(19) United States
(12) Patent Application Publication
(10) Pub. No.: US 2012/0000555 A1
(43) Pub. Date: Jan. 5, 2012

(54) FUEL SUPPLY SYSTEM

(75) Inventor: Takashi KOBA, Kariya-city (JP)

(73) Assignee: DENSO CORPORATION, Kariya-city (JP)

(21) Appl. No.: 13/175,203

(22) Filed: Jul. 1, 2011

(30) Foreign Application Priority Data
Jul. 1, 2010 (JP) 2010-150944

(51) Int. Cl. F15D 1/00

(52) U.S. Cl. 137/565.01

(57) ABSTRACT

A fuel supply system includes a fuel pump, a storing part, an injection nozzle, a communication part, a first fuel source, a second fuel source, and a fuel transfer passage part. The storing part stores fuel, which is drawn from a suction port. Part of fuel discharged from a discharge port is injected through the nozzle. The communication part communicates between the nozzle and the storing part. The communication part includes a first opening and a second opening, which are formed at positions where negative pressure is generated as a result of the injection of fuel through the nozzle. Fuel is drawn through the first and second openings, and is guided into the storing part through the communication part. The fuel flowing into the second opening is stored in the first source. The fuel stored in the second source is transferred into the first opening through the passage part.

### CROSS REFERENCE TO RELATED APPLICATION

This application is based on and incorporates herein by reference Japanese Patent Application No. 2010-150944 filed on Jul. 1, 2010.

### BACKGROUND OF THE INVENTION

1. Field of the Invention

The present invention relates to a fuel supply system that supplies fuel to outside of a fuel tank.

2. Description of Related Art

Conventionally, a fuel supply system that stably supplies fuel to the outside of a fuel tank despite low height of the fluid level of the fuel tank, is known. A fuel supply system described in, for example, JP-A-2004-293524, is accommodated inside a subtank, which is disposed in a fuel tank, and this fuel supply system supplies fuel in the subtank to a fuel-feeding object outside the fuel tank. In the fuel supply system, the subtank is accommodated in one side portion of the fuel tank, which is formed in a saddle-shape, and a fuel pump is accommodated inside the subtank.

The fuel supply system described in JP-A-2004-293524 includes two jet pumps. Specifically, the fuel supply system includes a jet pump for fuel drawing and a jet pump for fuel transfer. The fuel-drawing jet pump draws fuel stored in one of the saddle-shaped fuel tank, in which the subtank is accommodated, to supply the fuel into the subtank. The fuel-transfer jet pump suctions fuel stored in the other one of the saddle-shaped fuel tank to supply the fuel to the inside of the subtank, or to one side portion of the saddle-shaped fuel tank in which the subtank is accommodated. These jet pumps include injection nozzles that inject part of the fuel discharged from the fuel pump. The jet pumps draw in fuel using a negative pressure lower than the atmospheric pressure generated when injecting fuel through their injection nozzles. Accordingly, in the above-described fuel supply system, fuel including the fuel supplied to the fuel-feeding object and the fuel supplied to the two jet pumps needs to be discharged by the fuel pump.

In recent years, in accordance with the increase of output of an engine which is the fuel-feeding object, a flow of fuel that needs to be supplied to the engine is increased. Therefore, in the above fuel supply system, the problem that the flow of fuel that can be supplied to the two jet pumps decreases is caused. As one of methods of solving this problem, the flow of fuel that can be discharged by the fuel pump may be increased. However, in order to increase the flow of fuel that can be discharged by the fuel pump, it is necessary to increase a drive current of the fuel pump. For this reason, the increase of consumed electric power of the fuel supply system has become an issue.

### SUMMARY OF THE INVENTION

The present invention addresses at least one of the above disadvantages.

According to the present invention, there is provided a fuel supply system including a fuel pump, a storing part, an injection nozzle, a communication part, a first fuel source, a second fuel source, and a fuel transfer passage part. The fuel pump includes a suction port and a discharge port. The storing part stores fuel, which is drawn from the suction port. A part of fuel discharged from the discharge port is injected through the injection nozzle. The communication part communicates between the injection nozzle and the storing part. The communication part includes a first opening and a second opening, which are formed at positions where negative pressure is generated as a result of the injection of fuel through the injection nozzle. Fuel is drawn through the first opening and the second opening, and is guided into the storing part through the communication part. The fuel flowing into the second opening is stored in the first fuel source. Fuel is stored in the second fuel source. The second fuel source is different from the first fuel source. The fuel stored in the second fuel source is transferred into the first opening through the fuel transfer passage part.

### BRIEF DESCRIPTION OF THE DRAWINGS

The invention, together with additional objectives, features and advantages thereof, will be best understood from the following description, the appended claims and the accompanying drawings in which:

FIG. 1 is a schematic diagram illustrating a fuel supply system and a fuel tank in accordance with an embodiment of the invention;

FIG. 2 is a schematic sectional view illustrating the fuel supply system in accordance with the embodiment; and

FIG. 3 is a schematic partially enlarged sectional view illustrating vicinity of an injection nozzle in the fuel supply system in accordance with the embodiment.

### DETAILED DESCRIPTION OF THE INVENTION

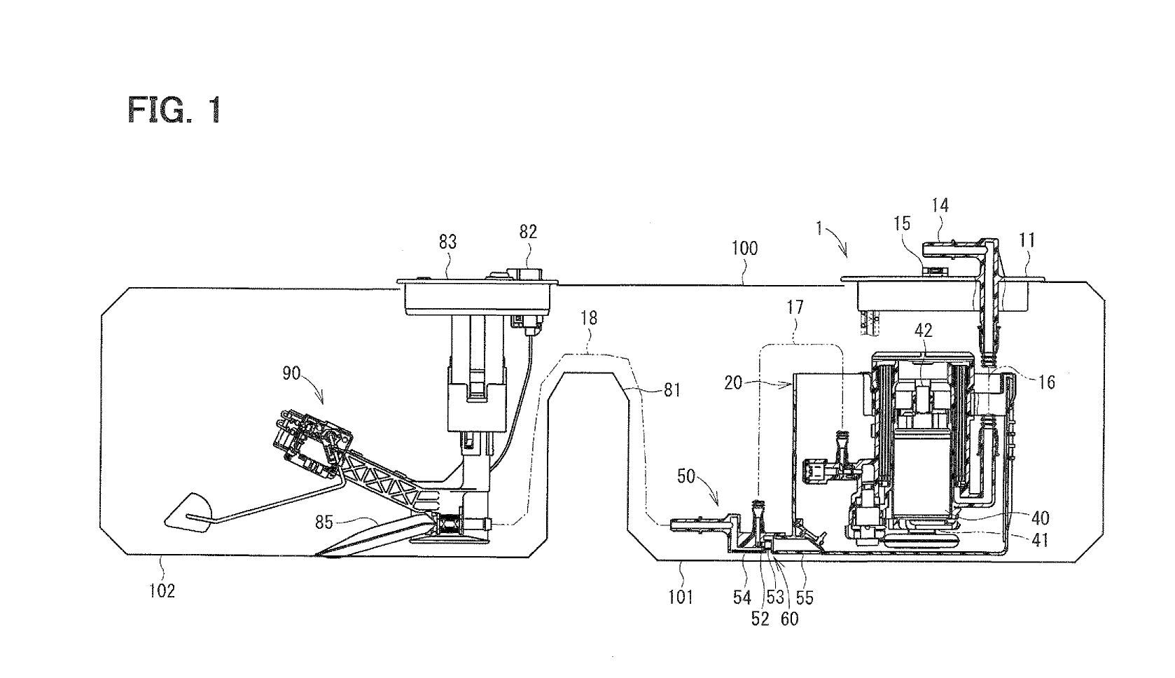

An embodiment of the invention will be described below in reference to the accompanying drawings. In the following description, the embodiment, in which the invention is applied to a fuel supply system that supplies fuel in a fuel tank to an engine of a vehicle, will be explained. The fuel tank that accommodates the fuel supply system of the present embodiment is formed in a saddle-shaped manner in accordance with a shape of an installation space for the vehicle. Specifically, as illustrated in FIG. 1, a fuel tank 100 is formed in a saddle-shape such that the tank 100 is divided by a partitioning wall 81 between a first fuel tank 101 and a second fuel tank 102. A fuel supply system 1 is accommodated in the first fuel tank 101, and a fuel level indicator 90 and a suction filter 85 are accommodated in the second fuel tank 102. The fuel level indicator 90 is connected to an electric connector 82, which is provided on a covering member 83 of the second fuel tank 102, via a lead wire (not shown). Fuel in the second fuel tank 102, which has been filtered through the suction filter 85, is transferred to the first fuel tank 101 through a freely bendable flexible hose 18.

The first fuel tank 101 may correspond to “a first fuel source in which the fuel flowing into the second opening is stored”, and the second fuel tank 102 may correspond to “a second fuel source which is different from the first fuel source (in which the fuel flowing into the second opening is stored)”. The fuel supply system 1 includes a reserve cup 20 that serves as a storing part, a fuel pump 40, a jet nozzle 52 that serves as an injection nozzle, a communication part 60, and a fuel transfer passage part 54.

An opening is formed on an upper wall of the fuel tank 100 on the first fuel tank 101-side, and this opening is closed by a covering member 11. The covering member 11 is formed in a shape of a circular disk from resin. A discharge port 14 and an electric connector 15 are disposed on the covering member 11. The electric connector 15 supplies electricity to the fuel pump 40 through a lead wire (not shown). The discharge port 14 is a pipe, through which fuel discharged from the fuel pump 40 flows toward the outside of the fuel tank 100. In the fuel supply system 1, other members than the covering member 11, such as the reserve cup 20, are accommodated in the first fuel tank 101.

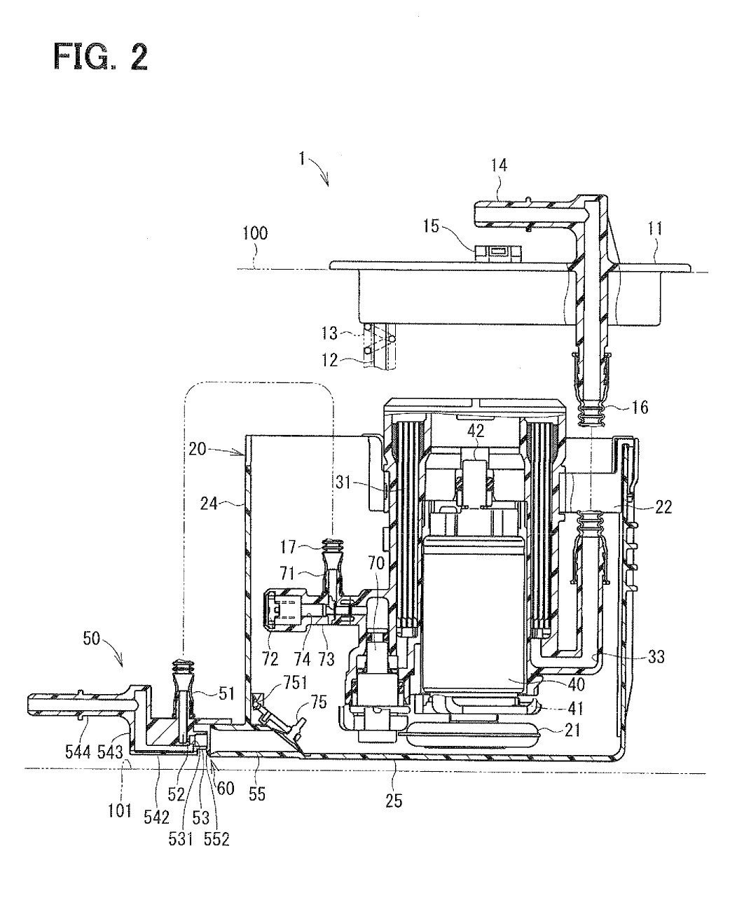

The fuel supply system 1 includes a shaft 12 that supports the covering member 11 and the reserve cup 20 to be relatively reciprocatable in its axial direction. One end portion of the shaft 12 in its axial direction is press-fitted into the covering member 11, and the other end portion of the shaft 12 is held by a supporting part (not shown) provided for the reserve cup 20. As illustrated in FIG. 2, a spring 13 that serves as an urging means is disposed on an outer peripheral side of the shaft 12. The spring 13 presses the covering member 11 and the reserve cup 20 in a direction to separate them away from each other.

The covering member 11 and the reserve cup 20 are held by the shaft 12, and pressed by the spring 13, so that they can relatively reciprocate in the axial direction. For example, even if the fuel tank 100, which is formed from resin, expands or contracts as a result of a change of its internal pressure or change of the fuel amount due to a temperature change, the reserve cup 20 is pressed against an inner bottom part of the fuel tank 100 by pressing force of the spring 13.

As illustrated in FIG. 2, the reserve cup 20 is formed into a cylindrical shape with a bottom portion having a peripheral wall part 24, and a bottom part 25 at an end portion of the peripheral wall part 24 on its opposite side from the covering member 11. The fuel pump 40, the suction filter 21, and so forth, are accommodated inside the reserve cup 20.

The fuel pump 40 includes a suction port 41 that suctions fuel and a discharge port 42 that discharges fuel. The fuel pump 40 is accommodated inside the reserve cup 20 with the lower side in FIG. 2 being a fuel suction side, and with the upper side being a fuel discharge side. The suction filter 21 is connected to the suction port 41. The suction filter 21 captures comparatively large foreign substances contained in the fuel, which is suctioned by the fuel pump 40 from the inside of the reserve cup 20. A fuel filter is disposed on an outer peripheral side of the fuel pump 40. The fuel filter 31 captures comparatively small foreign substances included in the fuel discharged from the fuel pump 40.

A downstream part of the fuel filter 31 branches into a fuel passage (not shown) connected to a pressure regulator 70, and a main fuel passage 33. The pressure regulator 70 regulates pressure of the fuel discharged from the discharge port 42 of the fuel pump 40 at a predetermined pressure. The fuel regulated to have the predetermined pressure is discharged from the discharge port 14 into the engine through the main fuel passage 33 and the flexible hose 16.

A portion on a downstream side of the pressure regulator 70 branches into a return passage part 73 and a drain port 71. A relief valve 72 that opens or closes a return passage 74 in accordance with the pressure in the return passage 74 is disposed at an end of the return passage part 73. When the relief valve 72 opens the return passage 74, the fuel in the return passage 74 is returned into the reserve cup 20. The drain port 71 is connected to a supply part 51 of the jet pump 50, which is hereinafter described in greater detail, via the flexible hose 17.

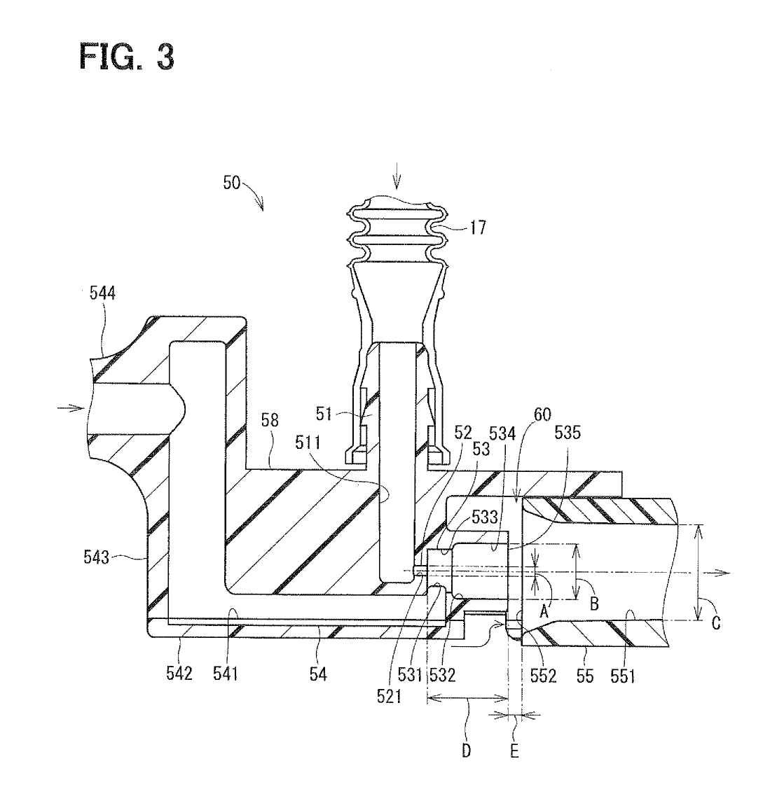

A configuration of the jet pump 50 will be described with reference to FIGS. 2 and 3. Arrows in FIG. 3 indicate a flow direction of fuel. The jet pump 50 is disposed on the bottom part of the first fuel tank 101. Accordingly, the jet pump 50 is located outside the reserve cup 20,

The jet pump 50 is composed of the jet nozzle 52, the communication part 60, the fuel transfer passage part 54, and so forth. The communication part 60 includes a first throat 53 and a second throat 55. In the present embodiment, the jet nozzle 52, the first throat 53, and the fuel transfer passage part 54 are integrally formed so as to constitute a jet pump main body part 58. The jet pump main body part 58 and the second throat 55 are formed as different members.

The supply part 51 is formed to extend upward from the jet pump main body part 58. One end portion of the supply part 51 is connected to the drain port 71 of the pressure regulator 70 through the flexible hose 17, and the other end portion of the supply part 51 is connected to the jet nozzle 52 (see FIG. 2). The supply part 51 includes a supply route 511 in the supply part 51, and supplies the fuel, which has been discharged from the drain port 71, to the jet nozzle 52.

The jet nozzle 52 injects a part of the fuel discharged from the discharge port 42 of the fuel pump 40. The jet nozzle 52 is formed at a lower end portion of the supply part 51, and a nozzle passage 521 is formed in the nozzle 52 (see FIG. 3). One end portion of the nozzle passage 521 is connected to the supply route 511, and the other end portion of the passage 521 is connected to the first throat 53. The nozzle passage 521 is formed to extend in a direction that is generally perpendicular to an axial direction of the supply route 511, i.e., in a direction that is generally parallel to the bottom part of the first fuel tank 101. The nozzle passage 521 is formed in a cylindrical shape on its inner surface, and the passage 521 is formed such that an inner diameter of the passage 521 is reduced compared to an inner diameter of the supply route 511. The fuel supplied through the supply route 511 is injected into the first throat 53 from the jet nozzle 52.

The first throat 53 is located on a downstream side of the jet nozzle 52 in a flow direction of the fuel injected through the jet nozzle 52. In other words, the first throat 53 is formed on the reserve cup 20-side of the jet nozzle 52, and a first throat passage 532 is formed in the throat 53. One end portion of the first throat passage 532 is connected to the nozzle passage 521, and the other end portion of the passage 532 opens into the outside of the pump 50. The first throat passage 532 is formed in a cylindrical shape on its inner surface, and the inner surface of the passage 532 is formed coaxially with the nozzle passage 521. The first throat passage 532 is formed in a stepwise manner such that the passage 532 includes a small diameter portion 533, and a large diameter portion 534 whose inner diameter is larger than the small diameter portion 533. The small diameter portion 533 and the large diameter portion 534 are both formed such that their inner diameters are larger than an inner diameter A of the nozzle passage 521 (see FIG. 3).

The fuel transfer passage part 54 transfers fuel which is accumulated in the second fuel tank 102. As illustrated in FIGS. 2 and 3, the fuel transfer passage part 54 is formed in a shape of a crank including a first linear portion 542, an upright portion 543, and a second linear portion 544. A transfer passage 541 is formed in the passage part 54. One end portion of the second linear portion 544 is connected to the suction filter 85 in the second fuel tank 102 through the flexible hose 18. Accordingly, the fuel in the second fuel tank 102, which has been filtered through the suction filter 85, flows along the transfer passage 541.

The first throat 53 includes a first opening 531 at a place where negative pressure is generated as a result of the injection of fuel through the jet nozzle 52 (see FIG. 3). The transfer passage 541 of the fuel transfer passage part 54 is connected to the first opening 531. Consequently, by the negative pressure generated when fuel is injected through the jet nozzle 52, the fuel in the second fuel tank 102 is drawn into the first throat passage 532 through the transfer passage 541. By forming the first throat 53 in a stepwise manner such that the first throat 53 has the small diameter portion 533 and the large diameter portion 534, an upper limit for the negative pressure generated in the first opening 531 is restricted.

The second throat 55 is located on a downstream side of the first throat 53, and guides fuel into the reserve cup 20. The second throat 55 is formed on the bottom part 25 of the reserve cup 20 integrally with the reserve cup 20. A second throat passage 551 is formed in the second throat 55, and one end portion of the second throat passage 551 opens into the outside as a second opening 552. The second opening 552 is formed to be opposed to an opening 535 of the first throat 53. Therefore, the opening 535 of the first throat 53 and the second opening 552 are arranged with a predetermined distance E therebetween.

An end portion of the second throat 55 on the reserve cup 20-side opens into the inside of the reserve cup 20. The second throat passage 551 is formed in a cylindrical shape on its inner surface, and the passage 551 is formed coaxially with the first throat passage 532. The second throat passage 551 is formed such that an inner diameter C of the second throat passage 551 is larger than an inner diameter B of the opening 535 of the first throat 53.

A place where negative pressure is generated as a result of the injection of fuel into the second throat 55 through the jet nozzle 52 via the first throat 53 is the second opening 552. Upon injection of fuel into the first throat 53 through the jet nozzle 52, the fuel injected through the jet nozzle 52 and the fuel suctioned through the first opening 531 are both injected through the opening 535 of the first throat 53 toward the second throat 55.

Due to the negative pressure generated when fuel is injected through the first throat 53, the fuel in the first fuel tank 101 is drawn into the second throat 55 through the second opening 552. The fuel suctioned into the second throat 55 from the second opening 552 is introduced into the reserve cup 20 together with the fuel injected through the jet nozzle 52 and the fuel drawn into the first throat 53 through the first opening 531. In order that fuel is drawn through the second opening 552 due to the negative pressure produced as a result of the injection of fuel through the first throat 53, the first throat passage 532 is formed such that its axial length has a predetermined length D.

As described above, the jet pump 50 of the present embodiment suctions the fuel stored in different fuel sources, i.e., the first fuel tank 101 and the second fuel tank 102 by the injection of fuel through the single jet nozzle 52. The jet pump 50 leads the suctioned fuel into the reserve cup 20 together with the fuel injected through the jet nozzle 52.

A check valve 75 is disposed at an end portion of the second throat 53 on the reserve cup 20-side (see FIG. 2). The check valve 75 prevents a backflow of the fuel drawn into the reserve cup 20 from the inside to the outside of the reserve cup 20. The check valve 75 is opened or closed by small force with a shaft portion 751 as its center. Thus, when a position of the fluid level in the first fuel tank 101 is high, the fuel in the first fuel tank 101 opens the check valve 75 due to its pressure to flow easily into the reserve cup 20. When the fluid level in the first fuel tank 101 is low, the fuel in the first fuel tank 101 opens the check valve 75 to flow into the reserve cup 20 together with the fuel injected through the jet nozzle 52 of the jet pump 50 and the fuel suctioned through the fuel transfer passage part 54.

Next, an operation of the fuel supply system 1 in accordance with the present embodiment will be described. Upon supply of a drive current to the fuel pump 40 from the electric connector 15, the fuel pump 40 suctions the fuel in the reserve cup 20 from the suction port 41 through the suction filter 21 (see FIG. 2). The fuel pump 40 pressurizes the suctioned fuel, and discharges the fuel from the discharge port 14 into the engine through the fuel filter 31, the main fuel passage 33, and the flexible hose 16.

The fuel discharged into the engine by the fuel pump 40 is regulated at a predetermined pressure through the pressure regulator 70. When the pressure of fuel discharged by the fuel pump 40 reaches the predetermined pressure or higher, a valve (not shown) in the pressure regulator 70 is opened due to this excess pressure, and the fuel flows out of the drain port 71 to be supplied to the supply part 51 of the jet pump 50. Therefore, part of the fuel discharged by the fuel pump 40 is fed into the supply part 51 of the jet pump 50.

When the fuel flowing out of the drain port 71 increases, the pressure from a downstream portion of the pressure regulator 70 to the supply part 51 of the jet pump 50 increases. Accordingly, if the pressure from the drain port 71 of the pressure regulator 70 to the jet nozzle 52 increases to reach a predetermined value or above, the relief valve 72 opens the return passage 74, so that the fuel is returned to the reserve cup 20 via the return passage 74.

More specifically, a flow rate of fuel returned to the reserve cup 20 from the relief valve 72 is expressed as follows. When a fuel pump is driven at a certain voltage value, it is assumed that a flow rate of fuel discharged from the fuel pump is 100 liters per hour (100 L/h). For example, it is assumed that a flow rate of fuel required in an engine is 50 L/h, and that a flow rate of fuel that needs to be supplied to the jet nozzle 52 is 20 L/h. In this case, the fuel returned to the reserve cup 20 through the relief valve 72 is calculated to be 100−50−20=30 L/h.

The fuel discharged through the drain port 71 is supplied to the supply part 51 of the jet pump 50, to be injected through the jet nozzle 52. Because of the negative pressure produced in the first opening 531 and the second opening 552, the fuel in the second fuel tank 102 is drawn through the first opening 531, and the fuel in the first fuel tank 101 is suctioned through the second opening 552. The suctioned fuel is guided into the reserve cup 20 together with the fuel injected from the jet nozzle 52.

As described above, according to the embodiment of the invention, in the supply unit 1, the fuel flowing into the first opening 531 is accumulated in the second fuel tank 102, and the fuel flowing into the second opening 552 is stored in the first fuel tank 101. In other words, by means of the injection of fuel through the sole jet nozzle 52, the fuel supply system 1 draws in the fuel stored in the two different places of the first fuel tank 101 and the second fuel tank 102.

As a result, in the present embodiment, the fuel injected from the jet nozzle 52 can be reduced. Thus, the fuel suctioned and discharged by the fuel pump 40 is decreased, and the drive current for the fuel pump 40 can thereby be reduced. Accordingly, the consumed electric power of the fuel supply system 1 can be reduced. Moreover, in the present embodiment, because the number of components is reduced, man-hours for assembly of the system are reduced.

Furthermore, in the present embodiment, the jet nozzle 52, the first throat 53, and the second throat 55 are formed into a cylindrical shape on their inner surfaces, and they are arranged such that their respective inner surfaces are coaxial. Consequently, since fuel is injected linearly through the jet nozzle 52 toward the first throat 53 and the second throat 55, the system 1 has an advantage in the suction of fuel through the first opening 531 and the second opening 552. Thus, the supply of fuel to the jet nozzle 52 at an undue flow rate is no longer necessary. Accordingly, the drive current of the fuel pump 40 can be reduced. Accordingly, the consumed electric power of the fuel supply system 1 can be reduced.

In the present embodiment, the jet nozzle 52, the first throat 53, and the second throat 55 are formed in a cylindrical shape on their inner surfaces. The first throat 53 is set to have a larger inner diameter than the jet nozzle 52, and the second throat 55 is set to have a larger inner diameter than the first throat 53. Accordingly, because the negative pressure is easily generated on the jet nozzle 52-side of the first throat 53 and on the first throat 53-side of the second throat 55, the system 1 has an advantage in the suction of fuel through the first opening 531 and the second opening 552. Hence, this feature is similar to the above invention in that the supply of fuel to the jet nozzle 52 at an undue flow rate is no longer necessary, and the drive current of the fuel pump 40 can be reduced. As a consequence, the consumed electric power of the fuel supply system 1 can be reduced.

In addition, in the present embodiment, the jet nozzle 52, the fuel transfer passage part 54, and the first throat 53 are integrally formed, and the second throat 55 and the reserve cup 20 are integrally formed. Accordingly, assembly man-hours for the system are decreased as a result of the reduction of the number of components. In the present embodiment, the fuel transfer passage part 54 is formed to have a crank shape adjacent to the jet nozzle 52. In consequence, the connection of the flexible hose 18 to the fuel transfer passage part 54 is facilitated. For this reason, the system 1 has an advantage in the reduction of man-hours for assembly.

The invention is not by any means limited to the above embodiment, and the invention can be practiced in various embodiments without departing from the scope of the invention. Firstly, in the above embodiment, the reserve cup 20 and the second throat 55 are formed together. Alternatively, the reserve cup 20 and the second throat may be formed as different members. Accordingly, the system 1 has an advantage in increase of flexibility in the arrangement of the second throat.

Secondly, in the above embodiment, the first throat 53 and the second throat 55 are formed as different members. Alternatively, the first throat and the second throat may be formed integrally. Accordingly, the system 1 has an advantage in the reduction of the number of components.

Thirdly, in the above embodiment, the second throat 55 is disposed outside the reserve cup 20. However, the second throat 55 is not necessarily disposed outside the reserve cup 20. For example, the second throat may be disposed inside the reserve cup. Moreover, the jet pump 50 may be disposed inside the reserve cup 20. Lastly, in the above embodiment, the fuel in the second fuel tank 102 is drawn through the first opening 531. Alternatively, depending on the shape of the fuel tank, for example, the fuel suctioned through the first opening may be supplied from more than one place.

In summary, the fuel supply system 1 of the above embodiment may be described as follows.

The fuel supply system 1 includes a fuel pump 40, a storing part 20, an injection nozzle 52, a communication part 53, 55, a first fuel source 101, a second fuel source 102, and a fuel transfer passage part 54. The fuel pump 40 includes a suction port 41 and a discharge port 42. The storing part 20 stores fuel, which is drawn from the suction port 41. A part of fuel discharged from the discharge port 42 is injected through the injection nozzle 52. The communication part 53, 55 communicates between the injection nozzle 52 and the storing part 20. The communication part 53, 55 includes a first opening 531 and a second opening 552, which are formed at positions where negative pressure is generated as a result of the injection of fuel through the injection nozzle 52. Fuel is drawn through the first opening 531 and the second opening 552, and is guided into the storing part 20 through the communication part 53, 55. The fuel flowing into the second opening 552 is stored in the first fuel source 101. Fuel is stored in the second fuel source 102. The second fuel source 102 is different from the first fuel source 101. The fuel stored in the second fuel source 102 is transferred into the first opening 531 through the fuel transfer passage part 54.

As described above, using the negative pressure produced at the time of the injection of fuel through the injection nozzle 52, the supply unit 1 of the present invention draws the fuel in the second fuel tank 102 into the storing part 20 through the fuel transfer passage part 54 and the first opening 531, and draws the fuel in the first fuel tank 101 into the storing part 20 through the second opening 552. In the fuel supply system 1 of the present invention, the fuel flowing into the first opening 531 and the second opening 552 is respectively accumulated in different fuel sources 102, 101. Thus, the fuel supply system 1 of the present invention can suction the fuel stored in different fuel sources 101, 102 at the same time by the injection of fuel through the one injection nozzle 52.

Consequently, as compared to a conventional fuel supply system including more than one jet pump to lead fuel stored in different fuel sources to a storing part, the fuel injected through the injection nozzle 52 can be reduced in the present invention. Thus, the fuel suctioned and discharged by the fuel pump 40 is decreased, and the drive current for the fuel pump 40 can thereby be reduced. As a result, in the present invention, consumed electric power of the fuel supply system 1 can be decreased. Moreover, in the present invention, the number of components is reduced compared with the system including more than one jet pump, so that assembly man-hours for the system 1 are decreased.

The injection nozzle 52, the first throat 53, and the second throat 55 may be formed in a cylindrical shape on their respective inner surfaces, which are arranged to be coaxial with each other. As a result of this, since fuel is injected linearly through the injection nozzle 52 toward the first throat 53 and the second throat 55, the negative pressure generated inside the first throat 53 and inside the second throat 55 is maximized. Therefore, the system 1 has an advantage in the suction of fuel from the first opening 531 and the second opening 552. As a consequence, because the system 1 obviates the necessity for fuel supply to the injection nozzle 52 at a superfluous flow rate, the drive current of the fuel pump 40 can be reduced. Accordingly, the consumed electric power of the fuel supply system 1 can be reduced.

The injection nozzle 52, the first throat 53, and the second throat 55 may be formed in a cylindrical shape on their respective inner surfaces. The first throat 53 may have a larger inner diameter than the injection nozzle 52. The second throat 55 may have a larger inner diameter than the first throat 53. Accordingly, the negative pressure is easily produced on the injection nozzle 52-side of the first throat 53 and on the first throat 53-side of the second throat 55. Thus, the system 1 is advantageous in drawing fuel through the first opening 531 and the second opening 552. Because fuel does not need to be supplied to the injection nozzle 52 at an excessive flow rate, similar to the above invention, the power consumption by the fuel supply system 1 can be lowered. In addition, the system 1 is limited to the formation of the first throat 53 and the second throat 55 into a cylindrical manner. However, they are not necessarily formed strictly cylindrically.

The fuel transfer passage part 54 may be formed in a shape of a crank in vicinity of the injection nozzle 52. Accordingly, it becomes easy to connect a pipe or the like for transferring fuel from the fuel source 102, which is different from the fuel source 101 that stores the fuel flowing into the second opening 552, to the fuel transfer passage part 54.

Additional advantages and modifications will readily occur to those skilled in the art. The invention in its broader terms is therefore not limited to the specific details, representative apparatus, and illustrative examples shown and described.

What is claimed is:

1. A fuel supply system comprising:
a fuel pump that includes a suction port and a discharge port;
a storing part that stores fuel, which is drawn from the suction port;
an injection nozzle through which a part of fuel discharged from the discharge port is injected;
a communication part that communicates between the injection nozzle and the storing part and includes a first opening and a second opening, which are formed at positions where negative pressure is generated as a result of the injection of fuel through the injection nozzle, wherein fuel is drawn through the first opening and the second opening, and is guided into the storing part through the communication part;
a first fuel source in which the fuel flowing into the second opening is stored;
a second fuel source in which fuel is stored and which is different from the first fuel source; and
a fuel transfer passage part through which the fuel stored in the second fuel source is transferred into the first opening.

2. The fuel supply system according to claim 1, wherein:
the communication part includes:
a first throat located on a downstream side of the injection nozzle in a flow direction of fuel, which is injected through the injection nozzle; and
a second throat located on a downstream side of the first throat in the flow direction of fuel;
fuel is guided into the storing part through the second throat;
the first opening is formed at a region of the first throat on an injection nozzle-side; and
the second opening is formed at a region of the second throat on a first throat-side.

3. The fuel supply system according to claim 2, wherein the injection nozzle, the first throat, and the second throat are formed in a cylindrical shape on their respective inner surfaces, which are arranged to be coaxial with each other.

4. The fuel supply system according to claim 2, wherein:
the injection nozzle, the first throat, and the second throat are formed in a cylindrical shape on their respective inner surfaces;
the first throat has a larger inner diameter than the injection nozzle; and
the second throat has a larger inner diameter than the first throat.

5. The fuel supply system according to claim 2, wherein:
the injection nozzle is formed integrally with the fuel transfer passage part and the first throat; and
the second throat is formed integrally with the storing part.

6. The fuel supply system according to claim 2, wherein the first throat is formed integrally with the second throat.

7. The fuel supply system according to claim 1, wherein the fuel transfer passage part is formed in a shape of a crank in vicinity of the injection nozzle.
